(19) United States
(12) Patent Application Publication
(10) Pub. No.: US 2024/0300106 A1
(43) Pub. Date: Sep. 12, 2024

(54) COLLABORATIVE ROBOT SYSTEM

(71) Applicant: NACHI-FUJIKOSHI CORP., Tokyo (JP)

(72) Inventor: Tatsurou FUJISAWA, Toyama (JP)

(73) Assignee: NACHI-FUJIKOSHI CORP., Tokyo (JP)

(21) Appl. No.: 18/596,674

(22) Filed: Mar. 6, 2024

(30) Foreign Application Priority Data
Mar. 6, 2023 (JP) 2023-33461

(51) Int. Cl. B25J 9/16; B25J 13/08

(52) U.S. Cl. CPC B25J 9/1664; B25J 9/1653; B25J 9/1676; B25J 13/086

(57) ABSTRACT

A collaborative robot system has a catching determination device. The catching determination device sets basic shapes, which encompasses a main body shape or a shape of an end effector, and calculates gaps or contacts between the basic shapes on the basis of the basic shapes, a posture of the robot, and a position of the end effector, thereby determining whether there is a possibility of a finger of an operator to be caught between arms of the robot or between the arm and the end effector.

### CROSS-REFERENCE TO RELATED APPLICATION

This application is based upon and claims the benefit of priority from the prior Japanese Patent Application No. 2023-033461, filed on Mar. 6, 2023, the entire contents of which are incorporated herein by reference.

### BACKGROUND OF THE INVENTION

### Field of the Invention

The present invention relates to a collaborative robot system having a safety function.

### Description of the Related Art

Safety measures are required for a so-called collaborative robot, an industrial robot that shares workspace with an operator. These safety measures can be classified into intrinsic safety and functional safety. Intrinsic safety is safety ensured as a structure or a mechanism. For example, intrinsic safety can include the use of a structure with ample space between robot arms that has less chance of catching the operator's fingers when the arms are folded. Functional safety is safety ensured by control. For instance, functional safety can be the implementation of a system where the robot halts if there is contact between the robot arm and the operator, thereby preventing the collision.

While intrinsic safety is a desirable measure, there is a problem with losing a degree of design freedom for reasons such as the need to secure a large space between the arms, which imposes constraints on a shape and a structure of the robot. Therefore, regarding a risk that cannot be handled by intrinsic safety, it is conceivable that using a robot that handles the risk by functional safety will typically operate in a normal mode without the restrictions imposed by functional safety, and the functional safety measures will only be activated when the operator approaches the robot.

Patent Document 1 describes a controller for a legged mobile robot equipped with at least a plurality of movable legs. The controller includes a catching detector including a pressure-sensitive sensor. The pressure-sensitive sensor is attached in a gap between a contact point between a movable portion of the robot with the rotation axis and a portion of the robot itself and the rotation axis.

Patent Document 2 describes a robot which includes a movable portion and a body portion. This robot includes a contact sensor or a pressure sensor in a portion where a gap between the movable portion and the body portion is equal to or less than a predetermined value.

### SUMMARY OF THE INVENTION

In order to solve the above problems, a representative configuration of a collaborative robot system according to the present invention includes: a robot having a plurality of arms and an end effector attached to a distal end of the arm; and a robot controller that controls an operation of the robot, in which the robot controller has: a storage device that stores link parameters, a main body shape of the robot including the plurality of arms, and a shape of the end effector; a posture calculation device that calculates a posture of the robot and a position of the end effector on the basis of the link parameters; and a catching determination device that determines presence or absence of a possibility that a finger of an operator is caught between the arms of the robot or between the arm and the end effector, and in which the catching determination device sets basic shapes, including the main body shape or the shape of the end effector, and based on the basic shapes, the posture of the robot, and the position of the end effector, calculating gaps or contacts between the basic shapes can determine whether there is a potential for the finger to be caught.

### BRIEF DESCRIPTION OF THE DRAWINGS

FIG. 1 is a diagram illustrating an overall configuration of a collaborative robot system according to an embodiment of the present invention;

FIG. 2A is a diagram schematically illustrating a situation in which fingers are caught by the robot in FIG. 1;

FIG. 2B is another diagram schematically illustrating a situation in which fingers are caught by the robot in FIG. 1;

FIGS. 3A and 3B are diagrams illustrating a basic shape of the robot in FIG. 1;

FIG. 4 is a functional block diagram of the collaborative robot system in FIG. 1;

FIG. 5 is a flowchart illustrating an operation of the collaborative robot system in FIG. 4;

FIG. 6 is a functional block diagram of a collaborative robot system according to another embodiment of the present invention;

FIG. 7 is a flowchart illustrating an operation of the collaborative robot system in FIG. 6; and

FIG. 8 is a flowchart illustrating another operation of the collaborative robot system in FIG. 6.

### DESCRIPTION OF THE EMBODIMENTS

Hereinafter, preferred embodiments of the present invention will be described in detail with reference to the accompanying drawings. Dimensions, materials, other specific numerical values, and the like illustrated in such embodiments are merely examples to facilitate understanding of the invention, and do not limit the present invention unless otherwise specified. Note that in the present specification and the drawings, elements having substantially the same function and configuration are denoted by the same reference numerals and redundant description is omitted, and elements not directly related to the present invention are not illustrated. For the purposes of the present disclosure, the term ‘a’ or ‘an’ entity refers to one or more of that entity. As such, the terms ‘a’ or ‘an’, ‘one or more’ and ‘at least one’ can be used interchangeably herein.

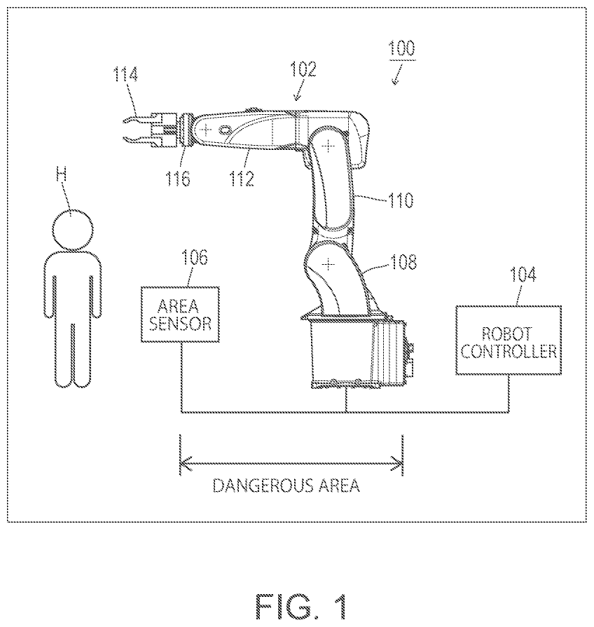

FIG. 1 is a diagram illustrating an overall configuration of a collaborative robot system 100 according to an embodiment of the present invention. The collaborative robot system 100 is an industrial robot system that shares a workspace with an operator H, and includes a robot 102, a robot controller 104, and an area sensor 106.

The area sensor 106 is connected to the robot controller 104 and detects that the operator H has entered a dangerous area. The dangerous area is a movable range of the robot 102 or an area extended by a predetermined distance from the movable range.

The robot 102 is operationally controlled by the robot controller 104, operating typically in a normal (or non-collaborative) mode without monitoring by a safety function; however, when the operator H enters a dangerous area, the robot 102 operates in a collaborative mode to work with the operator H, and the monitoring by the safety function becomes effective.

The robot 102 illustrated in FIG. 1 is a six-axis robot, and includes a turning arm 108, a first arm 110, a second arm 112, and an end effector 114. The end effector 114 is, for example, a hand or a gripper that grips a target object for gripping, and is attached to a distal end 116 of the second arm 112. In addition, in the robot 102, the first arm 110, the second arm 112, the distal end 116 of the second arm 112, and the end effector 114 are rotatable with respect to the turning arm 108 in a vertical plane perpendicular to a floor or the like on which the robot 102 is installed.

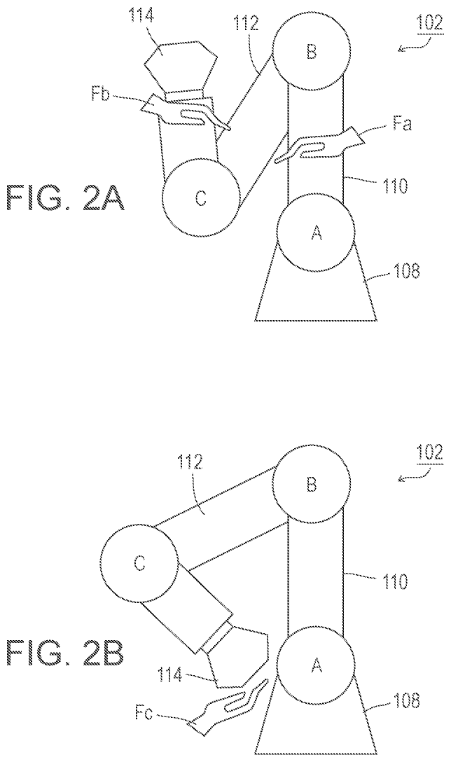

FIGS. 2A and 2B are diagrams schematically illustrating a situation in which fingers are caught by the robot 102 in FIG. 1. The first arm 110 of the robot 102 is rotatably coupled to the turning arm 108 via an axis A. The second arm 112 is rotatably coupled to the first arm 110 via an axis B. The end effector 114 is rotatably coupled to the second arm 112 via an axis C.

If a rotation angle of the axis B is restricted in the robot 102, it is possible to avoid a situation in which a finger Fa of the operator H is caught between the first arm 110 and the second arm 112 illustrated in FIG. 2A, and if a rotation angle of the axis C is restricted, it is possible to avoid a situation in which a finger Fb of the operator H is caught between the second arm 112 and the end effector 114. Physically (structurally) imposing such restrictions on axial angle, namely implementing measures based on intrinsic safety can lead to constraints on the shape and structure of the robot 102, resulting in a loss of design flexibility. In contrast, imposing restrictions an axial angle using software, that is, implementing functional safety, enables the easy avoidance of situations where the operator H's fingers, Fa and Fb, may get caught.

However, it is difficult to avoid the situation where the operator's fingers, Fc, may get caught between the end effector 114 and the swivel arm 108 or the first arm 110, as shown in FIG. 2B, by solely limiting a single axis angle using software.

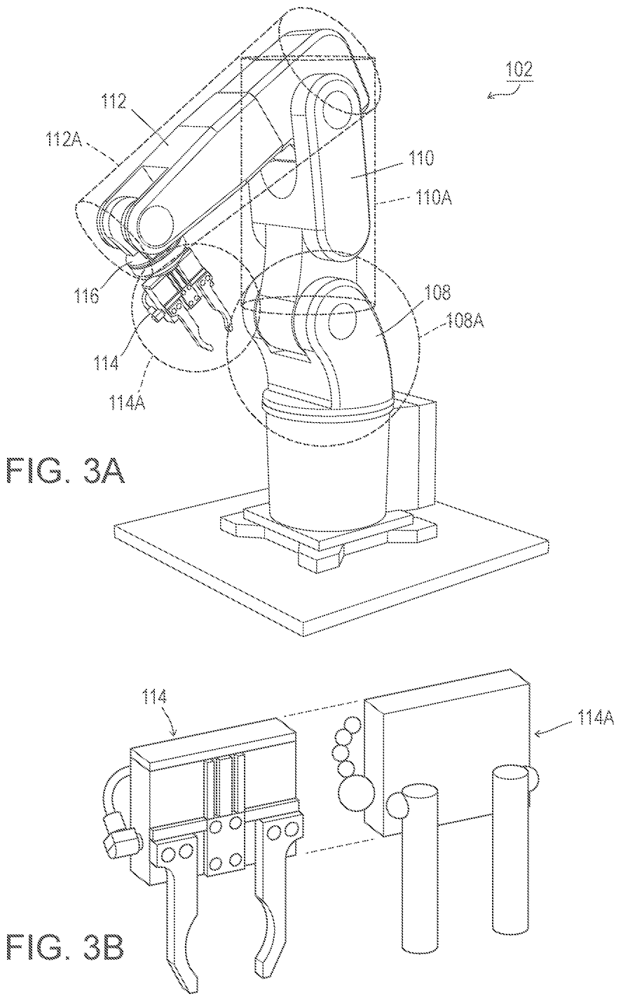

Therefore, in the collaborative robot system 100 that has the safety function according to the present embodiment, a function of setting basic shapes including a main body shape of a robot including a plurality of arms or a shape of an end effector (see FIGS. 3A and 3B) and calculating gaps or contacts between the basic shapes to determine the possibility of a finger being caught is adopted.

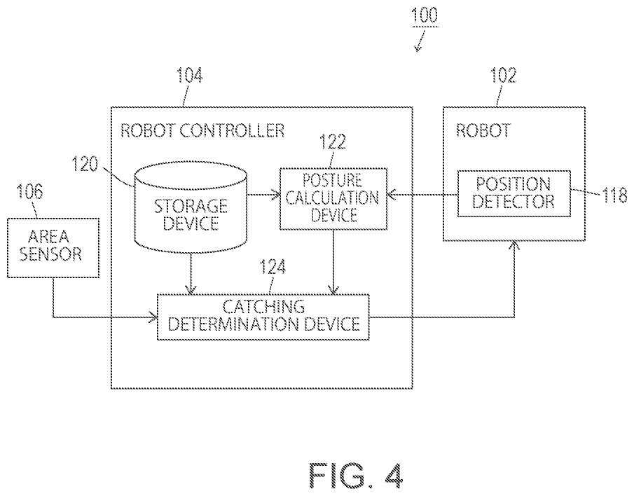

FIGS. 3A and 3B are diagrams illustrating a basic shape of the robot 102 in FIG. 1. As illustrated in FIG. 3A, the robot controller 104 (see FIGS. 1 and 4) sets a basic shape 108A of a sphere, which encompasses a shape of the turning arm 108 of the robot 102. In addition, the robot controller 104 sets basic shapes 110A and 112A of cylinders, which encompasses the shapes of the first arm 110 and the second arm 112, respectively. Hereinafter, the shape of the turning arm 108 and the shapes of the first arm 110 and the second arm 112 are also referred to as the main body shape of the robot 102. As such, the main body shape of the robot 102 is defined by a combination of the basic shapes of the sphere and the cylinders in the collaborative robot system 100.

In the example of FIG. 3A, the robot controller 104 sets a basic shape 114A of the sphere, which encompasses a shape of the end effector 114. However, a more detailed shape may be imitated. In the example illustrated in FIG. 3B, the basic shape 114A is defined by a combination of a rectangular parallelepiped, two cylinders, and a plurality of spheres.

FIG. 4 is a functional block diagram of the collaborative robot system 100 in FIG. 1. The robot 102 includes a position detector 118. The position detector 118 detects current positions of each of the axes A, B, and C (see FIGS. 2A and 2B) of the robot 102.

The robot controller 104 has a storage device 120, a posture calculation device 122, and a catching determination device 124. The storage device 120 stores the main body shape of the robot 102, the shape of the end effector 114, and link parameters.

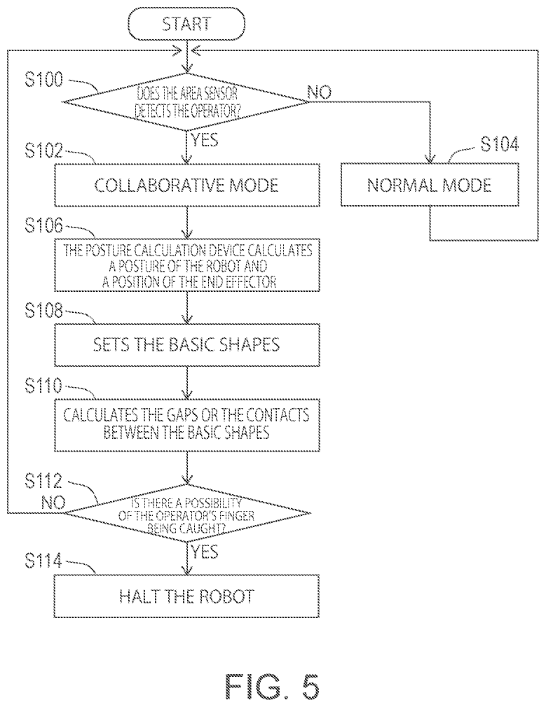

FIG. 5 is a flowchart illustrating an operation of the collaborative robot system 100 in FIG. 4. In the collaborative robot system 100, first, the area sensor 106 detects whether or not the operator H has entered the dangerous area (step S100). On the other hand, if the entry of the operator H into the dangerous area is detected in step S100 (Yes), the area sensor 106 outputs a collaborative mode signal. In response to the collaborative mode signal, the catching determination device 124 operates the robot 102 in the collaborative mode (step S102).

On the other hand, if the operator H has not entered the dangerous area in step S100 (No), the catching determination device 124 operates the robot 102 in the normal mode (step S104). After step S104, the process returns to step S100 again. As a result, the robot 102 operates in the normal mode while the operator H does not enter the dangerous area.

Next, in step S102, if the robot 102 is switched to the collaborative mode, the posture calculation device 122 calculates a posture of the robot 102 and a position of the end effector 114 based on the link parameters read from the storage device 120 and the current positions of each of the axes A, B, and C from the position detector 118 of the robot 102 (step S106).

Subsequently, the catching determination device 124 reads the main body shape of the robot 102 or the shape of the end effector 114 from the storage device 120, and sets the basic shapes 108A, 110A, 112A, and 114A (see FIGS. 3A and 3B), which encompass the main body shape of the robot 102 or the shape of the end effector 114 (step S108).

Furthermore, the catching determination device 124 calculates the gaps or the contacts between the basic shapes 108A, 110A, 112A, and 114A on the basis of the basic shapes 108A, 110A, 112A, and 114A, and the posture of the robot 102 and the position of the end effector 114 from the posture calculation device 122 (step S110).

Next, the catching determination device 124 calculates the gaps or the contacts between the basic shapes 108A, 110A, 112A, and 114A to determine whether there is a possibility of the operator H's finger being caught between the first arm 110 and the second arm 112, between the second arm 112 and the end effector 114, between the end effector 114 and the turning arm 108, or between the first arm 110 and the end effector 114 of the robot 102 (step S112).

As a specific example, 25 mm or more is secured for preventing the catching of fingers (numerical values are examples). If the basic shapes are not marginally offset from the main body shape, the determination of whether there is a “possibility of fingers being caught” is based on whether there is a gap of 25 mm between the basic shapes. If the basic shapes are set with a 12.5 mm margin offset from the main body shape, the determination of whether there is a “possibility of fingers being caught” is based on contact between the basic shapes.

In Step S112, if, however, there is a possibility that the finger is caught (Yes), the catching determination device 124 continues to stop the robot 102 (step S114). On the other hand, if there is no possibility that the finger is caught (No), the catching determination device 124 returns to step S100 and performs the following processing.

In step S100, the catching determination device 124 determines whether or not the operator H has moved away from the movable range of the robot 102 and left the dangerous area based on the output of the area sensor 106. However, if the operator H moves away from the movable range of the robot 102, that is, if the operator H is not detected (No), the catching determination device 124 operates the robot 102 in the normal mode in step S104. On the other hand, if the operator H does not move away from the movable range of the robot 102, that is, if the operator H is detected (Yes), the catching determination device 124 continues to operate the robot 102 in the collaborative mode in step S102.

As described above, in the collaborative robot system 100, the possibility of the operator H's finger being caught is determined by calculating the gaps or the contacts between the basic shapes 108A, 110A, 112A, and 114A based on the basic shapes 108A, 110A, 112A, and 114A of the robot 102, the posture of the robot 102, and the position of the end effector 114.

Therefore, according to the collaborative robot system 100, even if the finger is not actually caught, it is possible to determine a state in which there is a potential for the finger to be caught, and if there is a potential for the finger to be caught, the robot 102 will remain stopped, thus enhancing safety.

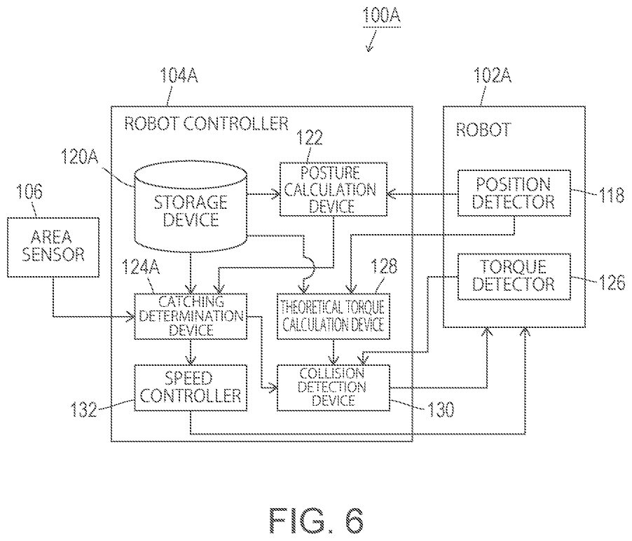

FIG. 6 is a functional block diagram of a collaborative robot system 100A according to another embodiment of the present invention. The collaborative robot system 100A includes a robot 102A and a robot controller 104A. The robot 102A differs from the robot 102 in that the robot 102A includes a torque detector 126 in addition to the position detector 118. However, the structure and outer shape of the robot 102A are the same as those of the robot 102.

The robot controller 104A has a storage device 120A, the posture calculation device 122, a catching determination device 124A, a theoretical torque calculation device 128, a collision detection device 130, and a speed controller 132. The storage device 120A stores the main body shape of the robot 102A including the shapes of the first arm 110 and the second arm 112 and the shape of the turning arm 108, the shape of the end effector 114, the link parameters, and a mass point model parameter.

The theoretical torque calculation device 128 calculates a theoretical torque based on the mass point model parameter read from the storage device 120A and the current positions of each of the axes A, B, and C from the position detector 118. The collision detector 130 detects a collision if an axial torque exceeds the theoretical torque calculated based on the theoretical torque from the theoretical torque calculation device 128 and the axial torque of each arm from the torque detector 126 provided in a joint of the robot 102A. The speed controller 132 controls an operation of the robot 102A at a low speed or a normal speed.

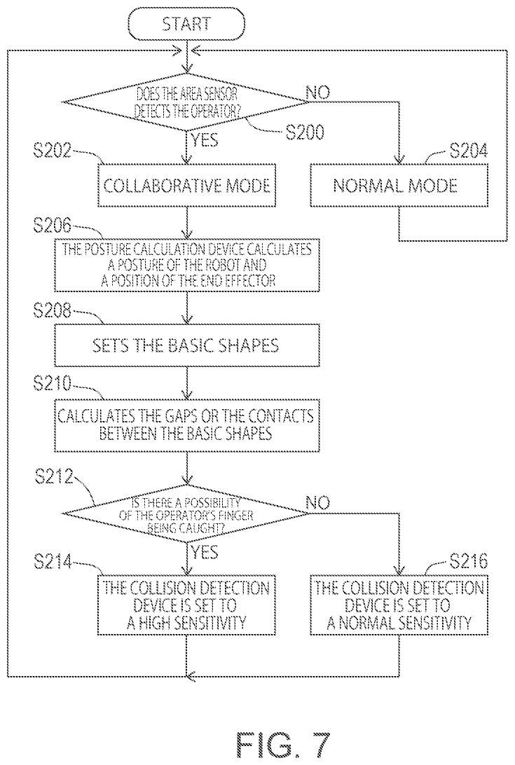

FIG. 7 is a flowchart illustrating the operation of the collaborative robot system 100A in FIG. 6. First, in the collaborative robot system 100A, the area sensor 106 detects whether or not the operator H has entered the dangerous area (step S200). Meanwhile, in Step S200, if the area sensor 106 detects the entry of the operator H into the dangerous area (Yes), the area sensor 106 outputs the collaborative mode signal. In response to the collaborative mode signal, the catching determination device 124A operates the robot 102A in the collaborative mode (step S202).

On the other hand, in step S200, if the operator H has not entered the dangerous area (No), the catching determination device 124A operates the robot 102A in the normal mode (step S204). After step S204, the process returns to step S200 again. As a result, the robot 102A operates in the normal mode while the operator H is not in the dangerous area.

Next, in step S202, if the robot 102A operates in the collaborative mode, the posture calculation device 122 calculates the posture of the robot 102A and the position of the end effector 114 on the basis of the link parameters read from the storage device 120A and the current positions of each of the axes A, B, and C from the position detector 118 of the robot 102A (step S206).

Subsequently, the catching determination device 124A reads the main body shape of the robot 102A or the shape of the end effector 114 from the storage device 120A, and sets the basic shapes 108A, 110A, 112A, and 114A (see FIGS. 3A and 3B) including the main body shape of the robot 102A or the shape of the end effector 114 (step S208).

Additionally, the catching determination device 124A calculates the gaps or the contacts between the basic shapes 108A, 110A, 112A, and 114A based on the basic shapes 108A, 110A, 112A, and 114A, and the posture of the robot 102A and the position of the end effector 114 from the posture calculation device 122 (step S210).

Next, the catching determination device 124A calculates the gaps or the contacts between the basic shapes 108A, 110A, 112A, and 114A to determine whether there is a possibility that the finger of the operator H is caught (step S212). On the other hand, if there is a possibility that the finger is caught (Yes), the collision detection device 130 is set to a high sensitivity (step S214). As a result, the collision detection device 130 controls the robot 102A to halt with an external force smaller than usual.

On the other hand, in step S212, when there is no possibility that the finger is caught (No), the catching determination device 124A sets the collision detection device 130 to a normal sensitivity (step S216). Furthermore, after steps S214 and S216, the catching determination device 124A returns to step S200 and performs the following processing.

In step S200, the catching determination device 124A determines whether or not the operator H has moved away from the movable range of the robot 102A and left the dangerous area based on the output of the area sensor 106. On the other hand, when the operator H moves away from the movable range of the robot 102A, that is, when the operator H is not detected (No), the catching determination device 124A operates the robot 102A in the normal mode in step S204. On the other hand, when the operator H does not move away from the movable range of the robot 102A, that is, if the operator H is detected (Yes), the catching determination device 124A continues to operate the robot 102A in the collaborative mode in step S202.

As described above, in the collaborative robot system 100A, whether there is a possibility that the finger of the operator H is caught is determined by calculating the gaps or the contacts between the basic shapes 108A, 110A, 112A, and 114A on the basis of the basic shapes 108A, 110A, 112A, and 114A of the robot 102A, the posture of the robot 102A, and the position of the end effector 114.

Therefore, according to the collaborative robot system 100A, it is possible to determine a state in which there is a potential for the finger to be caught even if the finger is not actually caught. Moreover, in the collaborative robot system 100A, if there is a possibility that the finger may be caught, the collision detection device 130 is made highly sensitive until the operator H moves away from the movable range of the robot 102A. Accordingly, in the collaborative robot system 100A, even when the finger is actually caught, the robot 102A can be halted more swiftly, and safety can be improved.

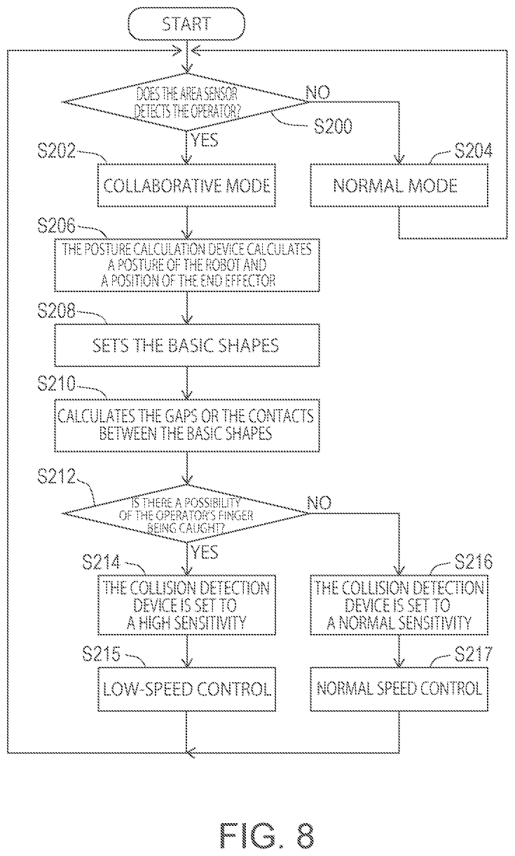

FIG. 8 is a flowchart illustrating another operation of the collaborative robot system 100A in FIG. 6. The operation of the collaborative robot system 100A is different from the operation illustrated in the flowchart of FIG. 7 in that processing of steps S215 and S217 is added.

Specifically, after setting the collision detection device 130 to the high sensitivity as illustrated in FIG. 8 (step S214), the catching determination device 124A controls the operation of the robot 102A at the low speed with the speed controller 132 (step S215). After setting the collision detection device 130 to the normal sensitivity (step S216), the catching determination device 124A controls the operation of the robot 102A at the normal speed with the speed controller 132 (step S217). After steps S215 and S217, the catching determination device 124A returns to step S200 described above, and if the operator H moves away from the movable range of the robot 102A and leaves the dangerous area, the robot 102A is operated in the normal mode.

Therefore, in the collaborative robot system 100A, if there is a possibility that the finger may be caught, the collision detection device 130 has the high sensitivity until the operator H moves away from the movable range of the robot 102A, and the robot 102A operates at the low speed.

Hence, according to the collaborative robot system 100A, even in a case where the robot 102A is controlled to stop with the smaller external force and the finger is actually caught, the robot 102A is halted more swiftly, and the robot 102A operates at the low speed. Thus, it is possible to further improve safety by reducing an impact applied to the finger.

Although the preferred embodiments of the present invention have been described above with reference to the accompanying drawings, it goes without saying that the present invention is not limited to such examples. It will be apparent to those skilled in the art that various changes or modifications can be conceived within the scope described in the claims, and it is understood that these naturally belong to the technical scope of the present invention.

What we claimed is:

1. A collaborative robot system comprising:
a robot having a plurality of arms and an end effector attached to a distal end of the arm; and
a robot controller that controls an operation of the robot,
wherein the robot controller has a storage device that stores link parameters, a main body shape of the robot including the plurality of arms, and a shape of the end effector;
a posture calculation device that calculates a posture of the robot and a position of the end effector based on the link parameters; and
a catching determination device that determines whether there is a potential for a finger of an operator to be caught between the arms of the robot or between the arm and the end effector, and
wherein the catching determination device sets basic shapes encompassing the main body shape or the shape of the end effector, and calculates gaps or contacts between the basic shapes based on the basic shapes, the posture of the robot, and the position of the end effector to determine a possibility of the finger being caught therebetween.

2. The collaborative robot system according to claim 1,
wherein if the catching determination device determines that there is a potential for the to be caught therebetween, the robot controller stops the robot until the operator moves away from a movable range of the robot.

3. The collaborative robot system according to claim 1,
wherein the robot controller further comprises a collision detection device that detects a collision between the arm or the end effector and the operator by a change in an axial torque of the arm; and
if the catching determination device determines that there is a potential for the finger to be caught therebetween, a detection sensitivity of the collision detection device is set to a high sensitivity.

4. The collaborative robot system according to claim 3,
wherein if the catching determination device determines that there is a potential for the finger to be caught, the robot controller slows down the operation of the robot.
